(19) United States
(12) Patent Application Publication
(10) Pub. No.: US 2011/0162016 A1
(43) Pub. Date: Jun. 30, 2011

(54) Inflight entertainment system video display synchronization

(76) Inventors: Gregory C. Petrisor, Los Angeles, CA (US); Allen Curtis, Mission Viejo, CA (US)

(21) Appl. No.: 12/930,215

(22) Filed: Dec. 30, 2010

Related U.S. Application Data
(60) Provisional application No. 61/335,084, filed on Dec. 31, 2009.

(51) Int. Cl. H04N 5/04; H04N 7/18

(52) U.S. Cl. 725/77; 348/500; 348/E05.009

(57) ABSTRACT

Inflight entertainment (IFE) system with remote control capability and video display synchronization. In one aspect, remote control capability and video display synchronization are used to extend the advantages of touch screen IFE passenger controls to airline passengers who cannot easily reach their seatback video display unit (VDU) due to, for example, cabin seating arrangements, age or disabilities. These advantages are realized through the expedient of a passenger control unit (PCU) touch screen video display that is synchronized with a VDU video display. When the passenger makes a selection by touching the PCU touch screen video display, the VDU video display reflects the selection at latency levels below human perception. In another aspect, remote control capability and video display synchronization are used to allow selections to be made remotely from the passenger's seat, such as by a flight attendant, parent, or interactive game competitor, and reflected on both a remote video display and the passenger's seatback VDU and/or PCU video display at latency levels below human perception.

### CROSS-REFERENCE TO RELATED APPLICATION

This application claims the benefit of U.S. provisional application No. 61/335,084 entitled “INFLIGHT ENTERTAINMENT SYSTEM WITH SYNCHRONIZED SEATBACK AND PASSENGER CONTROL UNIT VIDEO DISPLAYS,” filed on Dec. 31, 2009, the contents of which are incorporated herein by reference.

### BACKGROUND OF THE INVENTION

Inflight entertainment (IFE) systems have evolved significantly over the last 25 years. Prior to 1978, IFE systems consisted of audio-only systems. In 1978, Bell and Howell (Avicom Division) introduced a group viewing video system based on VHS tapes. In 1988, Airvision introduced the first in-seat video system allowing passengers to choose between several channels of broadcast video. In 1997, Swissair installed the first interactive video on demand (VOD) system. Currently, several IFE systems provide VOD with full digital video disc (DVD)-like passenger controls.

Sometimes, WE passenger controls are provided on a passenger control unit (PCU) mounted in a seat armrest. Passenger controls on a legacy PCU consist of mechanically actuated buttons having predetermined functions. The PCU communicates with a seatback video display unit (VDU) over a cable. FIG. 1 shows an exemplary graphical user interface (GUI) screen 101 displayed on a seatback VDU 100 that can be navigated using a legacy PCU 110. Legacy PCU 110 has navigation buttons 111 and a select button 112, among other mechanically actuated buttons. Screen 100 displays icons representing various WE functions. The passenger presses navigation buttons 111 to place focus on a desired icon (e.g. “movies” icon 102), then presses select button 112 to choose the IFE function associated with that icon. This conventional type of navigation can be cumbersome. Moreover, the ease of navigation decreases as the complexity of the GUI screen increases.

Other times, WE passenger controls are provided on a touch screen of a seatback VDU. FIG. 2 shows an exemplary GUI screen 201 displayed on a seatback VDU 200 that can be operated by touch. The passenger can press a desired one of icons 202 to select a desired IFE function, without navigation. Providing IFE passenger controls on a touch screen of a seatback VDU has several advantages, such as ease of use, flexibility in defining passenger controls, reduced cabling requirements and a reduced number of line replaceable units on an aircraft. However, providing IFE passenger controls on a touch screen is often impractical. For example, in many first class and business class seating arrangements, the distance from the passenger seat to the seatback and the pitch of the passenger seat does not permit the passenger to easily reach a seatback VDU. This problem is particularly significant because first and business class passengers are the most prized customers and expect an IFE feature set that is equivalent or superior to that offered to economy passengers.

Moreover, legacy PCU and touch screen seatback VDU IFE passenger controls are not well suited to allowing selections to be made remotely from the passenger's seat, such as by a flight attendant or parent, and reflected on the passenger's seatback VDU; nor are such conventional passenger controls amenable to advanced IFE applications, such as interactive gaming.

### SUMMARY OF THE INVENTION

The present invention, in a basic feature, provides an improved IFE system with remote control capability and video display synchronization. In one aspect, the present invention uses remote control capability and video display synchronization to extend the advantages of touch screen IFE passenger controls to airline passengers who cannot easily reach their seatback VDU due to, for example, cabin seating arrangements, age or disabilities. These advantages are realized in this aspect through the expedient of a PCU having a touch screen video display that is synchronized with a VDU video display. For example, when the passenger makes a selection by touching the PCU touch screen video display, the VDU video display reflects the selection at a latency level below human perception. In another aspect, the present invention's remote control capability and video display synchronization are used to allow selections to be made remotely from the passenger's seat, such as by a flight attendant, parent, or interactive game competitor, and reflected on both a remote video display and the passenger's seatback VDU and/or PCU video display at latency levels below human perception.

In one aspect of the invention, therefore, an IFE system comprises a VDU having a first video display; and a PCU communicatively coupled with the VDU and having a second video display, wherein user screens rendered on the first and second video displays are synchronized using output selection information communicated between the PCU and the VDU.

In some embodiments, the VDU is mounted to a seatback in front of a seat used by a passenger and wherein the PCU is detachably mounted in an armrest on the seat.

In some embodiments, the PCU and the VDU are communicatively coupled via an IFE distribution network.

In some embodiments, the second video display comprises a touch screen.

In some embodiments, the first and second video displays comprise touch screens.

In some embodiments, the user screens are GUI pages.

In some embodiments, the user screens are full motion video frames.

In some embodiments, the user screens rendered on the first and second video displays are differently formatted to account for size differences between the first and second video displays.

In some embodiments, the orientation of a user screen rendered on the second video display changes upon detachment of the PCU from the armrest.

In some embodiments, the change in orientation is from portrait to landscape.

In some embodiments, the orientation of a user screen rendered on the second video display changes upon attachment of the PCU to the armrest.

In some embodiments, the change in orientation is from landscape to portrait.

In some embodiments, the PCU transmits the output selection information to the VDU, and the VDU selects output for the first video display using the output selection information.

In some embodiments, the output selection information is logged by the PCU on a network storage device, and the VDU polls the network storage device for the output selection information and selects output for the first video display using the output selection information.

In some embodiments, the VDU polls the PCU for the output selection information and selects output for the first video display using the output selection information.

In some embodiments, the VDU transmits the output selection information to the PCU and the PCU selects output for the second video display using the output selection information.

In some embodiments, the output selection information comprises a GUI page identifier and the VDU selects output for the second video display using the GUI page identifier.

In some embodiments, the output selection information comprises an event identifier associated with an event received on the PCU from a peripheral controller device, the PCU transmits the event identifier to the VDU, and the VDU selects output for the second video display using the event identifier.

In some embodiments, the output selection information comprises VDU video data packets reformatted from VDU video data packets received on the PCU from the IFE distribution network, and the PCU transmits the reformatted video data packets to the VDU.

In some embodiments, the video data packets are User Datagram Protocol (UDP) packets.

In some embodiments, the first and second video displays are synchronized at a latency level below human perception.

In another aspect of the invention, an IFE system comprises a first unit having a first video display; and a second unit communicatively coupled with the first unit over an IFE distribution network and having a second video display, wherein the first unit is assigned to a first passenger and the second unit is not assigned to the first passenger, and wherein user screens rendered on the first and second video displays are synchronized at least in part by transmitting from the second unit to the first unit output selection information and having the first unit select output for the first video display using the output selection information.

In some embodiments, the output selection information comprises a GUI page identifier.

In some embodiments, the second unit is assigned to a second passenger.

In some embodiments, the IFE system further comprises a third unit communicatively coupled with the second unit over an IFE distribution network and having a third video display, wherein user screens rendered on the second and third video displays are synchronized at least in part by transmitting from the second unit to the third unit the output selection information and having the third unit select output for the third video display using the output selection information.

In some embodiments, the third unit is assigned to the first passenger.

In some embodiments, the first unit is a VDU and the third unit is a PCU.

In some embodiments, the third unit is assigned to a second passenger and the second unit is not assigned to the second passenger.

In some embodiments, the first and second video displays are synchronized at a latency level below human perception.

These and other aspects will be better understood by reference to the following detailed description taken in conjunction with the drawings that are briefly described below. Of course, the invention is defined by the appended claims.

### BRIEF DESCRIPTION OF THE DRAWINGS

FIG. 1 shows a GUI screen on a seatback VDU navigable using a legacy PCU.

FIG. 2 shows a GUI screen on a seatback VDU operable by touch.

FIGS. 3A and 3B show a paired seatback VDU and PCU in some embodiments of the invention.

FIG. 4 shows a PCU in some embodiments of the invention.

FIG. 5 shows an IFE system in some embodiments of the invention.

FIG. 6 shows VDU/PCU hardware and software elements in some embodiments of the invention.

FIG. 7A shows a method performed by a synchronization master for synchronizing GUI pages rendered on paired video displays in some embodiments of the invention.

FIG. 7B shows a method performed by a synchronization slave for synchronizing GUI pages rendered on paired video displays in some embodiments of the invention.

FIG. 8 shows a method performed by a device redirector for synchronizing user screens rendered on paired video displays by reflecting on the user screens activity events captured on a peripheral controller device in some embodiments of the invention.

FIG. 9 shows a method performed by a network manager for synchronizing user screens rendered on paired video displays with full motion video received from an IFE distribution network in some embodiments of the invention.

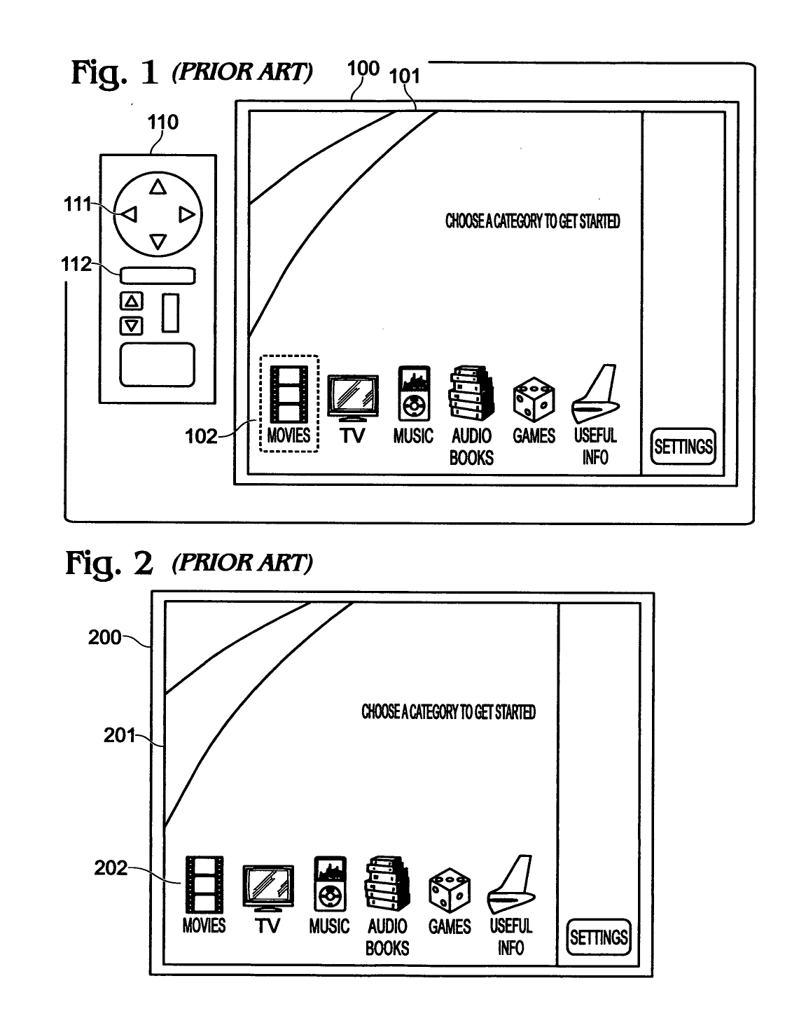

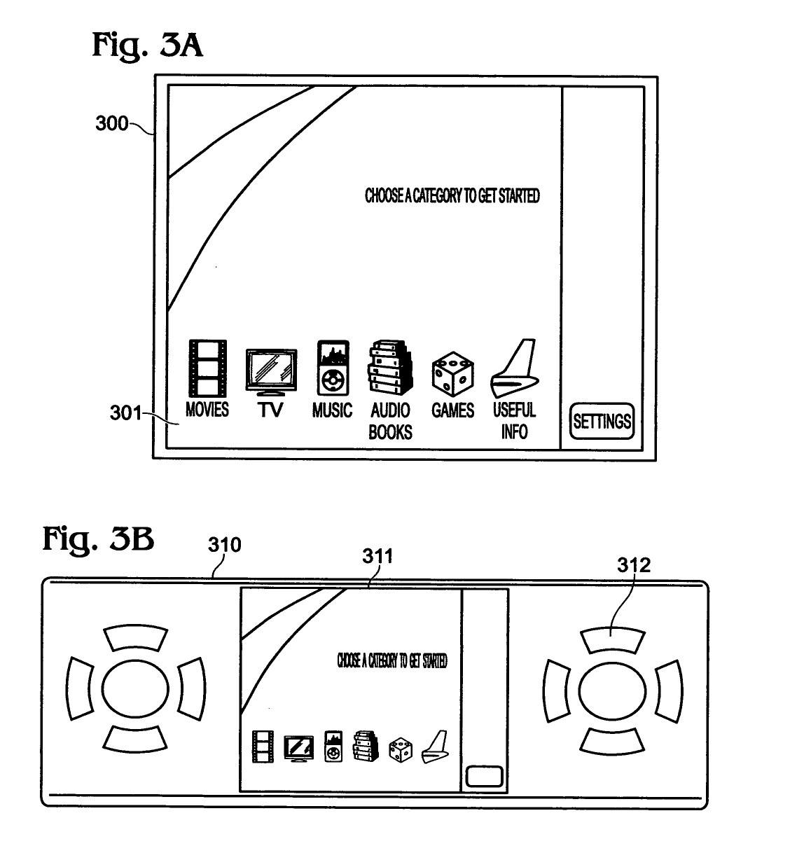

### DETAILED DESCRIPTION OF A PREFERRED EMBODIMENT

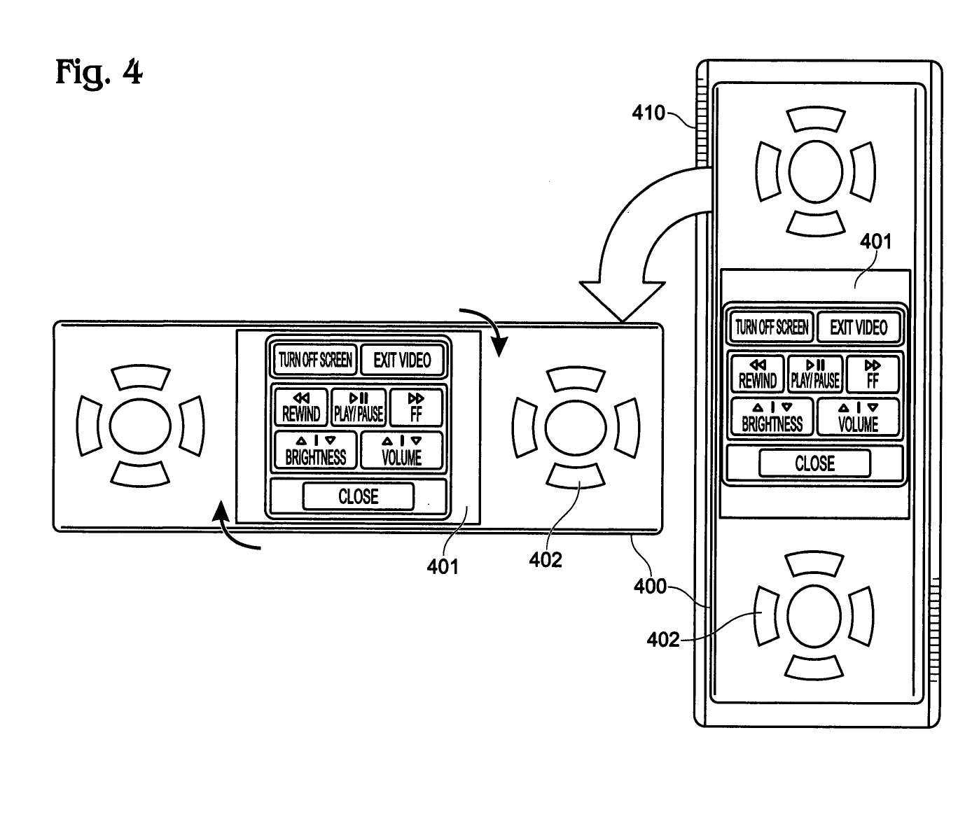

FIGS. 3A and 3B show a paired seatback VDU 300 and PCU 310 in some embodiments of the invention. VDU 300 and PCU 310 are used by the same passenger and are communicatively coupled over an IFE distribution network. VDU 300 is mounted to the back of the seat directly in front of the seat where the passenger who uses VDU 300 and PCU 310 sits. The seat to which VDU 300 is mounted is often too far away from the passenger to be used as a touch screen video display. To remedy this, PCU 310 is detachably mounted in an armrest of the passenger's seat. PCU 310 has a touch screen video display 311 as well as mechanically actuated control buttons 312. The user screens rendered on VDU video display 301 and PCU video display 311 are synchronized. Thus, when the passenger makes a selection by touching video display 311, video display 301 reflects the selection at a latency level below human perception.

User screens rendered on video displays 301, 311 may be identically formatted, or may be differently formatted to account for size differences between VDU video display 301 and PCU video display 311. VDU video display 301 may be a touch screen video display or a standard video display. Even if unreachable by the passenger, implementing VDU video display 301 as a touch screen video display has advantages in, for example, allowing a flight attendant to assist the passenger in using the IFE system by making touch-based selections on VDU video display 301. User screens are synchronized using synchronization software executed on VDU 300 and PCU 310 under processor control.

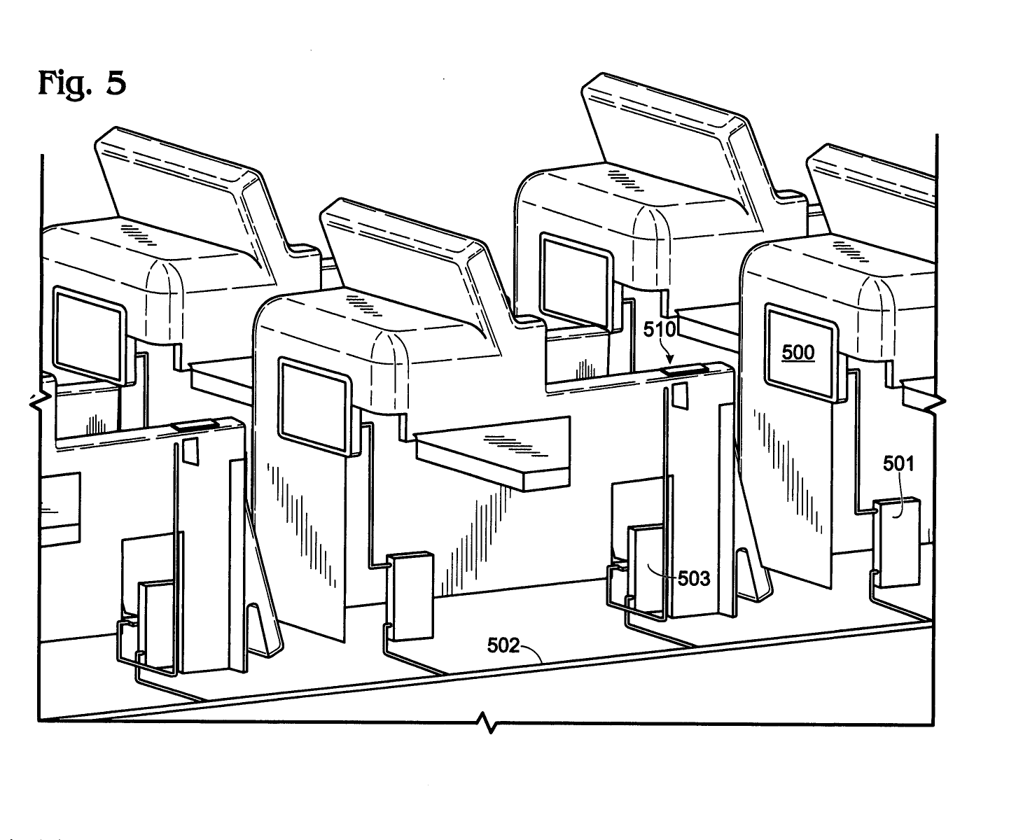

FIG. 4 shows a PCU 400 in some embodiments of the invention. PCU 400 has a touch screen video display 401 and mechanically actuated control buttons 402. PCU 400 is detachably mounted to an armrest 410 at a passenger seat. To improve the passenger's viewing experience, the orientation of user screens rendered on PCU video display 401 automatically switches between portrait and landscape based on whether or not PCU 400 is presently mounted in armrest 410. When PCU 400 is in the docked (i.e., mounted) position, user screens are rendered on PCU video display 401 in a portrait orientation. When PCU 400 is in the undocked position, user screens are rendered on PCU video display 401 in a landscape orientation. The change in screen orientation may be triggered automatically by detachment/attachment of PCU 400 from/to armrest 410. For example, PCU 400 may have a mechanical push pin that is released when PCU 400 is detached from armrest 410, causing a change in user screen orientation from portrait to landscape, and that is pushed inward when PCU 400 is attached to armrest 410, causing a change in user screen orientation from landscape to portrait. In other embodiments, an optical sensor or latching mechanism may trigger automatic changes in screen orientation upon detachment/attachment of PCU 400 from/to armrest 410. In some embodiments, changes in screen orientation may additionally or alternatively be realized by pushing one of control buttons 402.

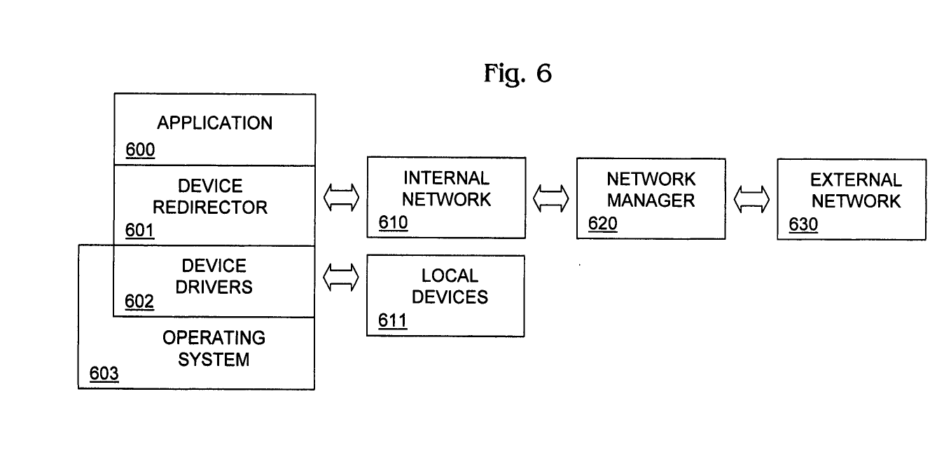

FIG. 5 shows an IFE system in some embodiments of the invention. In this system, a seatback VDU 500, which may or may not have a touch screen video display, is communicatively coupled with a PCU 510, which has a touch screen video display, via an IFE distribution network. VDU 500 is connected to a VDU-side seat electronics box (SEB) 501 through a local cable. The VDU-side SEB 501 is connected, in turn, to a PCU-side SEB 503 via a multipurpose cable 502 that is used both to deliver video and control signals between head end servers and seat end VDUs and PCUs and to deliver video and control signals between PCU 510 and VDU 500. By leveraging multipurpose cable 502 to provide communicative coupling between paired seatback VDU 500 and PCU 510, the need for a dedicated seat-to-seat cable connecting VDU 500 and PCU 510 is obviated.

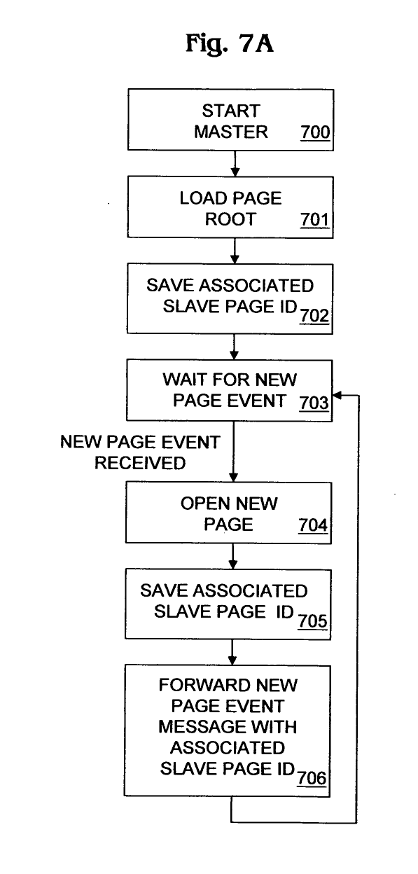

FIG. 6 shows VDU/PCU hardware and software elements in some embodiments of the invention. One instance of the elements resides on the seatback VDU and another resides on the PCU with which the VDU is paired. The elements include an application 600 that runs on top of a device redirector 601, which runs on device drivers 602, which are part of an operating system 603. All of these software elements 600, 601, 602, 603 are executable by a processor collocated with the software on the VDU or PCU. Device drivers 601 drive specific local devices 611, which may be internal or external to the VDU or PCU. By way of example, internal local devices on the VDU or PCU may include a touch screen interface and a credit card reader, and external local devices on the VDU or PDU may include an auxiliary controller or game controller. Application 600 and device redirector 601 have access via an internal network 610 to an external network 630, such as an IFE distribution network, under control of a network manager 620. Device redirector 601 captures inputs from local devices 611 and relays status signals based thereon via external network 630 to the unit with which the VDU or PCU is paired, instead of or in addition to passing these status signals to application 600 for local processing. In addition, device redirector 601 receives status signals via external network 630 from the unit with which the VDU or PCU is paired and passes the status signals to application 600 for local processing.

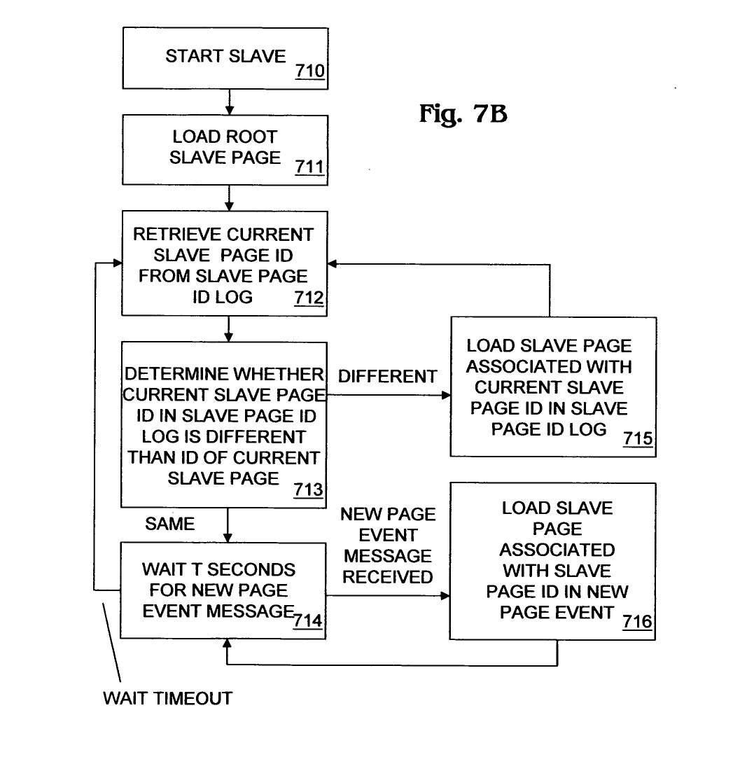

FIG. 7A shows a method performed by a synchronization master under processor control for synchronizing GUI pages rendered on paired VDU and PCU video displays in some embodiments of the invention. The synchronization master is an application executed by a processor on either the VDU, the PCU, or on both simultaneously, and runs in conjunction with a synchronization slave on its VDU or PCU counterpart. It is also possible for both the VDU and PCU to run a synchronization master and synchronization slave simultaneously, in which case user screens on the paired VDU and PCU video displays are synchronized to reflect touch screen inputs made on both the VDU and PCU.

After the synchronization master launches (700), the master loads the root GUI page for the master video display based on configuration information for the master video display (701). The master saves to a slave page ID log in local storage or remote storage (e.g., on a IFE network storage device) an identifier of a slave GUI page corresponding to the root GUI page (702). The master then waits for a new page event (703), such as a selection made by touching a button on the root GUI page on the master video display. After receiving a new page event, the master opens the new GUI page (704) on the master video display. The master then saves in local or remote storage an identifier of a slave GUI page corresponding to the new GUI page (705) and transmits to the synchronization slave a new page event message having the identifier of the slave GUI page (706). The flow then returns to Step 703.

FIG. 7B shows a method performed by a synchronization slave under processor control for synchronizing GUI pages rendered on paired VDU and PCU video displays in some embodiments of the invention. The synchronization slave is an application executed by a processor on the VDU, the PCU, or both simultaneously, and runs in conjunction with a synchronization master on its PCU or VDU counterpart.

After the synchronization slave launches (710), the slave loads the root GUI page for the slave video display based on configuration information for the slave video display (711). The slave then retrieves from a slave page ID log on local or remote storage an identifier of a slave GUI page (712). The slave then compares the identifier of the slave GUI page retrieved from the slave page ID log with the identifier of the currently loaded GUI page for the slave video display (713). If the identifiers do not match, the slave loads the slave GUI page associated with the identifier retrieved from the slave page ID log (715) and the flow returns to Step 712. If the identifiers match, the slave waits T seconds (where T is a predetermined number) for a new page event message from the synchronization master (714). If T seconds elapse without receiving a new page event message from the master, the flow returns to Step 712 (i.e., the slave periodically polls the slave page ID log). If a new page event message is received before T seconds elapse, the slave loads the new page associated with the identifier in the new page event message (716) and returns to Step 714.

Working together, the synchronization master and synchronization slave provide a robust mechanism for synchronizing GUI user screens on a VDU/PCU pair at a level below human perception. Moreover the above method may be extended to one-to-many scenarios (i.e., one synchronization master and multiple synchronization slaves) to synchronize user screens presented on three or more associated video displays.

Moreover, it may be desirable to allow selections to be made remotely from the passenger's seat, such as by a flight attendant or parent, and reflected on both a remote video display and the passenger's seatback VDU and/or PCU video display at latency levels below human perception. For example, it may be desirable to have a flight attendant or a parent make IFE selections on a VDU and/or PCU touch screen associated with a first seat and have the IFE selections reflected on the VDU and/or PCU associated with a second seat at a latency level below human perception. Moreover, it may be desirable to have IFE selections from one VDU and/or PCU touch screen reflected on a large number of other VDUs and/or PCUs for purposes of IFE system testing. To achieve these and other ends, the method of FIG. 7 may be extended over an IFE distribution network to synchronize user screens rendered on video displays that are not all associated with a single VDU/PCU pair to reflect IFE selections made on one of the video displays.

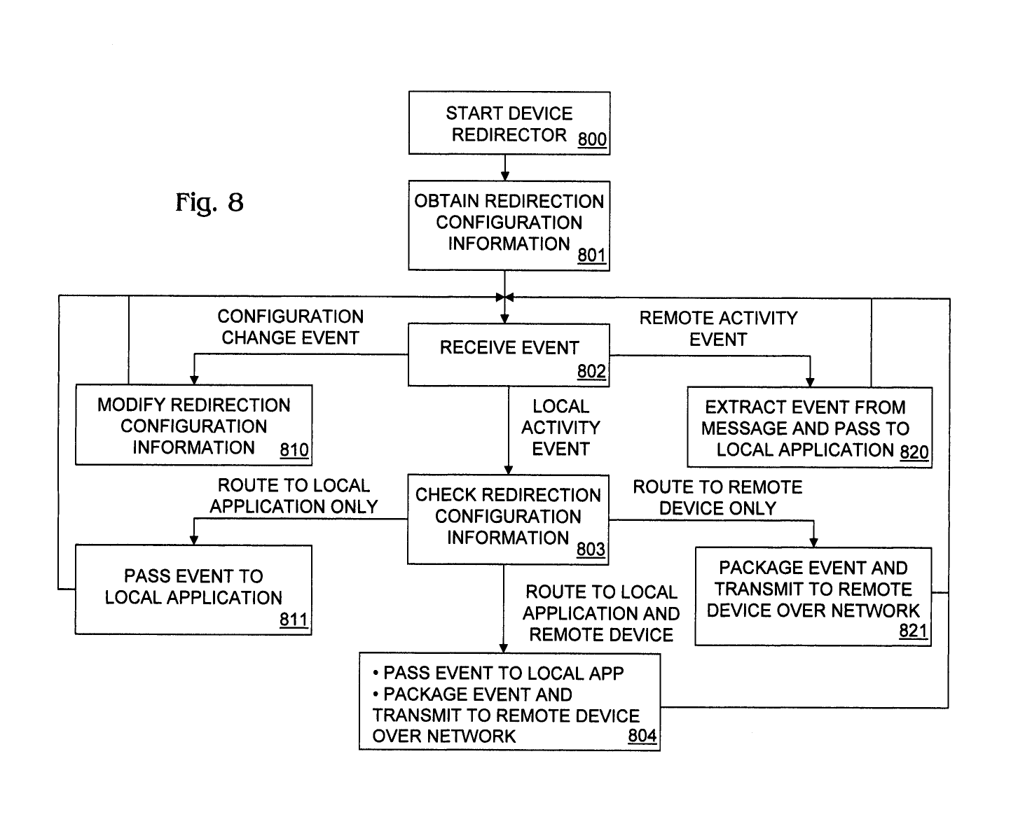

Turning now to FIG. 8, a method performed by a device redirector under processor control for synchronizing user screens rendered on multiple video displays by reflecting on user screens activity events captured on a peripheral controller device is shown in some embodiments of the invention. A peripheral controller device may be, for example, an auxiliary controller or a game controller and may be a local device attached to the VDU or PCU on which the device redirector is running or a remote device attached to a VDU or PCU other than the VDU or PCU on which the device redirector is running. In the remote device scenario, the other VDU or PCU may be associated with the same passenger (e.g., paired with the VDU or PCU on which the device redirector is running) or a different passenger. For example, the other VDU or PCU may be associated with another passenger who is playing a multiplayer game with the passenger and activity events captured on a peripheral controller device may be, for example, joystick moves or action button presses made by the other passenger on a game controller.

After the device redirector launches (800), the redirector obtains redirection configuration information for a peripheral controller device (801). This information indicates whether activity events received from the peripheral controller device are to be routed to a local application (i.e., an application running on the same VDU or PCU on which the redirector is running), redirected to a remote device (i.e., a VDU or PCU other than the one on which the redirector is running), or both. This information may be retrieved from local or remote storage (e.g., IFE network storage device). The redirector then waits for an event and branches according to the event type. If the redirector receives a configuration change event, the redirector updates the redirection configuration information for the peripheral controller device (810) and returns to Step 802. If the redirector receives an activity event message from a remote device in relation to an activity event originating on a peripheral controller device, the redirector extracts the activity event and routes it to a local application which reflects the event on the local user screen (820). If the redirector receives an activity event from a local peripheral controller device, the redirector consults redirection configuration information stored in local or remote storage (803). If the redirection configuration information indicates to only route activity events from the local peripheral controller device to a local application, the redirector passes the activity event to the local application which reflects the event on the local user screen (811). If the redirection configuration information indicates to only redirect activity events from the local peripheral controller device to a remote device, the redirector packages the activity event in an activity event message and routes the event message to the remote device, whereupon an application running on the remote device reflects the event on a remote user screen (821). If the redirection configuration information indicates to both route activity events from the local peripheral controller device to the local application and redirect such activity events to the remote device, redirector does both, whereupon the event is reflected on both the local user screen and a remote user screen (804). After handling the activity event, the flow returns to Step 802 where the redirector awaits the next event.

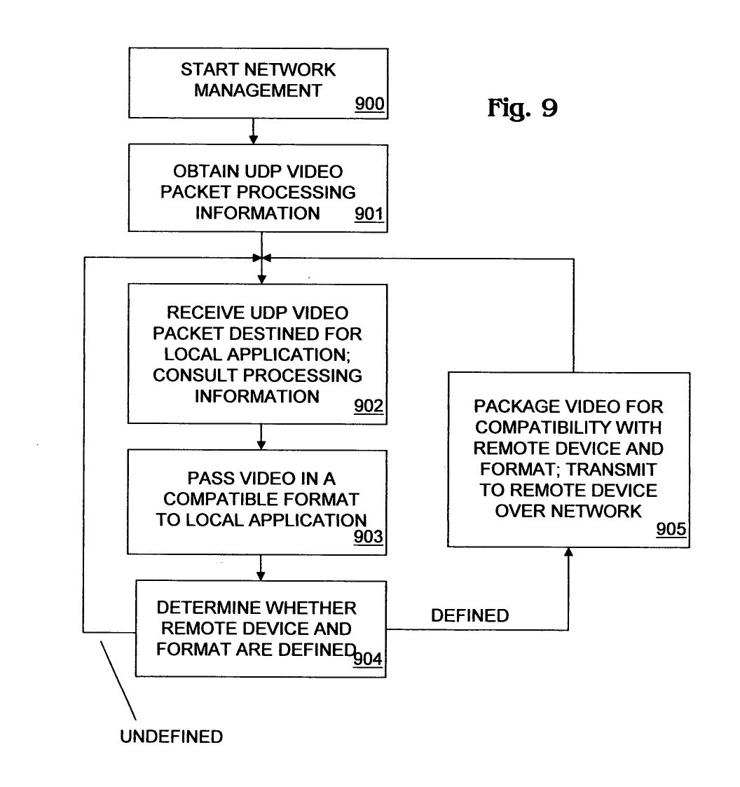

Finally, FIG. 9 shows a method performed by a network manager under processor control for synchronizing user screens rendering full motion video frames received on paired VDU and PCU video displays from an IFE distribution network in some embodiments of the invention. This method provides a low latency synchronization that allows audio directly received by a PCU from the IFE distribution network and video redirected to the PCU from a seatback VDU that is paired with the PCU to be synchronized at a latency level below human perception.

After the network manager launches (900), the manager obtains UDP video packet processing information (901). This information indicates whether full motion video in UDP video packets should be redirected to a remote device (e.g., a PCU paired with the VDU on which the manager is running) and, if so, how the redirected full motion video should be formatted for compatibility with the remote device, as well as how the full motion video should be formatted for compatibility when routed to a local application (e.g., an application running on the VDU on which the manager is running) (901). This information may be retrieved from local or remote storage (e.g., IFE network storage device). The manager then receives a UDP video packet destined for the local application and consults the UDP video packet processing information (902). The manager packages the full motion video in a format compatible with the local application and routes it to the local application, which locally renders user screens depicting full motion video frames (903). The manager then determines whether a remote device and format are defined in the UDP video packet processing information (904). If not, the flow returns to Step 902. If so, the manager also packages the full motion video in a format compatible with the remote device and redirects it to the remote device, whereupon user screens depicting full motion video frames are rendered remotely (905), whereafter the flow returns to Step 902.

In some embodiments, the received UDP video packets are controlled using Real-Time Streaming Protocol (RTSP). The manager generates Internet Group Management Protocol (IGMP) packets from the received UDP video packets and sends them to the remote device for rendering on a selected IGMP channel. The remote device video display replicates the video being shown on the local device with no human perceptible latency.

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come with in the meaning and range of equivalents thereof are intended to be embraced therein.

What is claimed is:

1. An inflight entertainment (IFE) system, comprising:
a video display unit (VDU) having a first video display, and
a passenger control unit (PCU) communicatively coupled with the VDU and having a second video display, wherein user screens rendered on the first and second video displays are synchronized using output selection information communicated between the PCU and the VDU.

2. The WE system of claim 1, wherein the VDU is mounted to a seatback in front of a seat used by a passenger and wherein the PCU is detachably mounted in an armrest on the seat.

3. The IFE system of claim 1, wherein the PCU and the VDU are communicatively coupled via an IFE distribution network.

4. The IFE system of claim 1, wherein the second video display comprises a touch screen.

5. The IFE system of claim 1, wherein the first and second video displays comprise touch screens.

6. The IFE system of claim 1, wherein the user screens are graphical user interface (GUI) pages.

7. The IFE system of claim 1, wherein the user screens are full motion video frames.

8. The IFE system of claim 1, wherein the user screens rendered on the first and second video displays are differently formatted to account for size differences between the first and second video displays.

9. The IFE system of claim 1, wherein the orientation of a user screen rendered on the second video display changes upon detachment of the PCU from the armrest.

10. The IFE system of claim 9, wherein the change in orientation is from portrait to landscape.

11. The IFE system of claim 1, wherein the orientation of a user screen rendered on the second video display changes upon attachment of the PCU to the armrest.

12. The IFE system of claim 11, wherein the change in orientation is from landscape to portrait.

14. The IFE system of claim 1, wherein the PCU transmits the output selection information to the VDU, and the VDU selects output for the first video display using the output selection information.

15. The IFE system of claim 1, wherein the output selection information is logged by the PCU on a network storage device, and the VDU polls the network storage device for the output selection information and selects output for the first video display using the output selection information.

16. The IFE system of claim 1, wherein the VDU polls the PCU for the output selection information and selects output for the first video display using the output selection information.

17. The IFE system of claim 1, wherein the VDU transmits the output selection information to the PCU, and the PCU selects output for the second video display using the output selection information.

18. The IFE system of claim 1, wherein the output selection information comprises a GUI page identifier and the VDU selects output for the second video display using the GUI page identifier.

19. The IFE system of claim 1, wherein the output selection information comprises an event identifier associated with an event received on the PCU from a peripheral controller device, wherein the PCU transmits the event identifier to the VDU, and wherein the VDU selects output for the second video display using the event identifier.

20. The IFE system of claim 1, wherein the output selection information comprises VDU video data packets reformatted from VDU video data packets received on the PCU from the IFE distribution network, and wherein the PCU transmits the reformatted video data packets to the VDU.

21. The IFE system of claim 20, wherein the video data packets are User Datagram Protocol (UDP) packets.

22. The IFE system of claim 1, wherein the first and second video displays are synchronized at a latency level below human perception.

23. An IFE system, comprising:
a first unit having a first video display; and
a second unit communicatively coupled with the first unit over an IFE distribution network and having a second video display, wherein the first unit is assigned to a first passenger and the second unit is not assigned to the first passenger, and wherein user screens rendered on the first and second video displays are synchronized at least in part by transmitting from the second unit to the first unit output selection information and having the first unit select output for the first video display using the output selection information.

24. The IFE system of claim 23, wherein the output selection information comprises a GUI page identifier.

25. The IFE system of claim 23, wherein the second unit is assigned to a second passenger.

26. The IFE system of claim 23, further comprising a third unit communicatively coupled with the second unit over an IFE distribution network and having a third video display, wherein user screens rendered on the second and third video displays are synchronized at least in part by transmitting from the second unit to the third unit the output selection information and having the third unit select output for the third video display using the output selection information.

27. The IFE system of claim 23, wherein the third unit is assigned to the first passenger.

28. The IFE system of claim 23, wherein the first unit is a VDU and the third unit is a PCU.

29. The IFE system of claim 23, wherein the third unit is assigned to a second passenger and the second unit is not assigned to the second passenger.

30. The IFE system of claim 23, wherein the first and second video displays are synchronized at a latency level below human perception.
